(19) United States
(12) Patent Application Publication
(10) Pub. No.: US 2025/0309352 A1
(43) Pub. Date: Oct. 2, 2025

(54) ELECTROLYTIC SOLUTION FOR LITHIUM-ION SECONDARY BATTERY, AND LITHIUM-ION SECONDARY BATTERY

(71) Applicant: MURATA MANUFACTURING CO., LTD., Kyoto (JP)

(72) Inventors: Satoshi UMEZU, Kyoto (JP); Mitsunori NAKAMOTO, Kyoto (JP); Hiroki MITA, Kyoto (JP)

(21) Appl. No.: 19/240,482

(22) Filed: Jun. 17, 2025

Related U.S. Application Data
(63) Continuation of application No. PCT/JP2023/041714, filed on Nov. 21, 2023.

(30) Foreign Application Priority Data
Jan. 12, 2023 (JP) 2023-003372

(51) Int. Cl. H01M 10/0567; H01M 10/0525

(52) U.S. Cl. CPC H01M 10/0567; H01M 10/0525; H01M 2300/0025

(57) ABSTRACT

A lithium-ion secondary battery includes a positive electrode, a negative electrode, and an electrolytic solution. The electrolytic solution includes a nitrile compound, and a fluorinated alcohol represented by Formula (1). The nitrile compound includes one or more cyano groups in a molecule. A content of the nitrile compound in the electrolytic solution is within a range from 0.5 wt % to 5 wt % both inclusive. A content of the fluorinated alcohol in the electrolytic solution is within a range from 0.05 wt % to 1 wt % both inclusive.

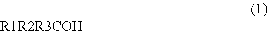

where:
each of R1, R2, and R3 is any one of a hydrogen group, an alkyl group, or a fluorinated alkyl group; and
at least one of R1, R2, or R3 is the fluorinated alkyl group.

### CROSS REFERENCE TO RELATED APPLICATIONS

The present application is a continuation of International Application No. PCT/JP2023/041714, filed on Nov. 21, 2023, which claims priority to Japanese Patent Application No. 2023-003372, filed on Jan. 12, 2023, the entire contents of which are incorporated herein by reference.

### BACKGROUND

The present technology relates to an electrolytic solution for a lithium-ion secondary battery, and to a lithium-ion secondary battery.

Various kinds of electronic equipment, including mobile phones, have been widely used. Such widespread use has promoted development of a lithium-ion secondary battery as a power source that is smaller in size and lighter in weight and allows for a higher energy density. The lithium-ion secondary battery includes a positive electrode, a negative electrode, and an electrolytic solution (an electrolytic solution for a lithium-ion secondary battery). A configuration of the lithium-ion secondary battery has been considered in various ways.

Specifically, in a lithium-ion secondary battery, an electrolytic solution includes an alcohol such as ethanol, and a content of the alcohol in the electrolytic solution is defined.

### SUMMARY

The present technology relates to an electrolytic solution for a lithium-ion secondary battery, and to a lithium-ion secondary battery.

Although consideration has been given in various ways regarding a configuration of a lithium-ion secondary battery, a battery characteristic of the lithium-ion secondary battery is not sufficient yet. Accordingly, there is room for improvement in terms of the battery characteristic of the lithium-ion secondary battery.

It is desirable to provide an electrolytic solution for a lithium-ion secondary battery, and a lithium-ion secondary battery that each make it possible to achieve a superior battery characteristic.

An electrolytic solution for a lithium-ion secondary battery according to an embodiment of the present technology includes a nitrile compound, and a fluorinated alcohol represented by Formula (1). The nitrile compound includes one or more cyano groups in a molecule. A content of the nitrile compound is greater than or equal to 0.5 wt % and less than or equal to 5 wt %. A content of the fluorinated alcohol is greater than or equal to 0.05 wt % and less than or equal to 1 wt %.

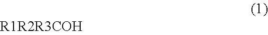

where:
each of R1, R2, and R3 is any one of a hydrogen group, an alkyl group, or a fluorinated alkyl group; and
at least one of R1, R2, or R3 is the fluorinated alkyl group.

A lithium-ion secondary battery according to an embodiment of the present technology includes a positive electrode, a negative electrode, and an electrolytic solution. The electrolytic solution has a configuration similar to that of the electrolytic solution for the lithium-ion secondary battery according to an embodiment of the present technology described above.

According to the electrolytic solution for the lithium-ion secondary battery of an embodiment of the present technology or the lithium-ion secondary battery of an embodiment of the present technology, the electrolytic solution for the lithium-ion secondary battery includes the nitrile compound and the fluorinated alcohol, the content of the nitrile compound is greater than or equal to 0.5 wt % and less than or equal to 5 wt %, and the content of the fluorinated alcohol is greater than or equal to 0.05 wt % and less than or equal to 1 wt %. Accordingly, it is possible to achieve a superior battery characteristic.

Note that effects of the present technology are not necessarily limited to those described herein and may include any of a series of effects in relation to the present technology.

### BRIEF DESCRIPTION OF THE FIGURES

FIG. 1 is a perspective diagram illustrating a configuration of a lithium-ion secondary battery according to an embodiment of the present technology.

FIG. 2 is a sectional diagram illustrating a configuration of a battery device illustrated in FIG. 1.

FIG. 3 is a block diagram illustrating a configuration of an application example of the lithium-ion secondary battery.

FIG. 4 is a sectional diagram illustrating a configuration of a lithium-ion secondary battery for testing.

### DETAILED DESCRIPTION

The present technology is described below in further detail including with reference to the drawings.

A description is given first of an electrolytic solution for a lithium-ion secondary battery according to an embodiment of the present technology. The electrolytic solution for a lithium-ion secondary battery will hereinafter be simply referred to as the “electrolytic solution”.

The electrolytic solution is to be used in a lithium-ion secondary battery, which is an electrochemical device. However, the electrolytic solution may be used in other electrochemical devices that are different from the lithium-ion secondary battery. The other electrochemical devices are not particularly limited in kind, and specific examples thereof include a capacitor.

The electrolytic solution is a liquid electrolyte, and is used as a mediator of lithium ions in the lithium-ion secondary battery. The electrolytic solution includes a nitrile compound and a fluorinated alcohol.

The term “nitrile compound” is a generic term for a compound that includes one or more cyano groups (—CN) in a molecule. Only one nitrile compound may be used, or two or more nitrile compounds may be used.

The nitrile compound includes, in addition to the one or more cyano groups, a central group to which the one or more cyano groups are introduced. Although not particularly limited in kind, the central group is specifically a group in which one or more hydrogen groups are removed from a hydrocarbon group. The number of the hydrogen groups to be removed from the hydrocarbon group is determined in accordance with the number of the cyano groups to be introduced to the central group.

The term “hydrocarbon group” is a term for a group including carbon and hydrogen. The hydrocarbon group may have a chain structure or a cyclic structure, or may be in a state where the chain structure and the cyclic structure are combined with each other.

Specific examples of the nitrile compound that includes one cyano group in the molecule, that is, a mononitrile compound, include acetonitrile.

Specific examples of the nitrile compound that includes two cyano groups in the molecule, that is, a dinitrile compound, include succinonitrile, glutaronitrile, adiponitrile, and 3,3′-(ethylenedioxy)dipropionitrile.

Specific examples of the nitrile compound that includes three cyano groups in the molecule, that is, a trinitrile compound, include 1,2,3-propanetricarbonitrile, 1,3,5-pentanetricarbonitrile, 1,3,4-hexanetricarbonitrile, 1,3,6-hexanetricarbonitrile, 1,3,5-cyclohexanetricarbonitrile, and 1,3,5-benzenetricarbonitrile.

Needless to say, specific examples of the nitrile compound may include a compound that includes four or more cyano groups in the molecule.

In particular, the nitrile compound is preferably a compound that includes two cyano groups in the molecule, that is, the dinitrile compound. One reason for this is that this facilitates formation of a favorable film on a surface of a negative electrode in the lithium-ion secondary battery including the electrolytic solution, and thus suppresses gas generation during storage of the lithium-ion secondary battery.

The fluorinated alcohol is an alcohol to which a fluorine group (—F) is introduced, and more specifically, a compound represented by Formula (1). Only one fluorinated alcohol may be used, or two or more fluorinated alcohols may be used.

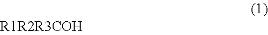

where:
each of R1, R2, and R3 is any one of a hydrogen group, an alkyl group, or a fluorinated alkyl group; and
at least one of R1, R2, or R3 is the fluorinated alkyl group.

R1, R2, and R3 are not particularly limited as long as each of R1, R2, and R3 is any one of the hydrogen group (—H), the alkyl group, or the fluorinated alkyl group, as described above.

The alkyl group may have a straight-chain structure, or may have a branched structure. Carbon number of the alkyl group is preferably within a range from 1 to 4 both inclusive, in particular, although not particularly limited thereto. One reason for this is that this improves solubility and compatibility of the fluorinated alcohol.

Specific examples of the alkyl group include a methyl group, an ethyl group, a propyl group, and a butyl group. Note that the structure of the alkyl group is not limited to the straight-chain structure, and may thus be branched, as described above. Accordingly, for example, the propyl group may be an n-propyl group or an isopropyl group. As other examples, the butyl group may be an n-butyl group, a sec-butyl group, an isobutyl group, or a tert-butyl group.

The fluorinated alkyl group is a group in which one or more hydrogen groups in the alkyl group are each substituted with a fluorine group. Details (the configuration and the carbon number) of the alkyl group are as described above.

Specific examples of the fluorinated alkyl group include a perfluoromethyl group, a perfluoroethyl group, a perfluoropropyl group, and a perfluorobutyl group. Note that specific examples of the fluorinated alkyl group are not limited to perfluoro groups, and may thus include a monofluoromethyl group, a monofluoroethyl group, a monofluoropropyl group, and a monofluorobutyl group.

Here, as described above, one or more of R1, R2, or R3 are each the fluorinated alkyl group. One reason for this is that the fluorinated alcohol is an alcohol to which one or more fluorine groups are introduced as described above, and therefore has to include one or more fluorine atoms as a constituent element. Thus, any compound in which each of R1, R2, and R3 is either the hydrogen group or the alkyl group is excluded from the fluorinated alcohol described here.

In particular, two or more of R1, R2, or R3 are each preferably the fluorinated alkyl group. One reason for this is that this facilitates the formation of a favorable film on the surface of the negative electrode and thus sufficiently decreases electric resistance in the lithium-ion secondary battery including the electrolytic solution.

Specific examples of the fluorinated alcohol include CF₃CH₂OH, CF₂HCH₂OH, CFH₂CH₂OH, CF₃CF₂CH₂OH, CF₃CFHCH₂OH, CF₃CH₂CH₂OH, CF₂HCF₂CH₂OH, (CF₃)₂CHOH, CF₃C(CH₃)HOH, (CF₃)₃COH, (CF₃)₂C(CH₃)OH, (CF₃)C(CH₃)₂OH, CF₃CF₂CF₂CH₂OH, CF₃CF₂CH₂CH₂OH, CF₃CH₂CH₂CH₂OH, CF₃CF₂CH(OH)CF₃, CF₃CF₂CH(OH)CH₃, CF₃CH₂CH(OH)CF₃, CF₃CH₂CH(OH)CH₃, and CH₃CH₂CH(OH)CF₃.

### [Content]

In the electrolytic solution, a relationship between a content of the nitrile compound and a content of the fluorinated alcohol is made appropriate to improve a battery characteristic of the lithium-ion secondary battery including the electrolytic solution. More specifically, two conditions described below are satisfied regarding the relationship between the content of the nitrile compound and the content of the fluorinated alcohol.

Firstly, a content C1 of the nitrile compound in the electrolytic solution is within a range from 0.5 wt % to 5 wt % both inclusive.

Secondly, a content C2 of the fluorinated alcohol in the electrolytic solution is within a range from 0.05 wt % to 1 wt % both inclusive.

One reason why the two conditions are satisfied regarding the contents C1 and C2 is that this makes the relationship between the contents C1 and C2 appropriate, and thus decreases electric resistance in the lithium-ion secondary battery including the electrolytic solution.

More specifically, the nitrile compound has a capability of suppressing a decomposition reaction of the electrolytic solution. Accordingly, when the electrolytic solution includes the nitrile compound, the decomposition reaction of the electrolytic solution is suppressed and as a result, gas generation caused by the decomposition reaction of the electrolytic solution is suppressed.

However, when the electrolytic solution includes the nitrile compound, the lithium-ion secondary battery including the electrolytic solution increases in electric resistance, while the decomposition reaction of the electrolytic solution is suppressed. Thus, there arises a trade-off relationship between suppression of the gas generation and suppression of an increase in electric resistance, that is, a relationship in which improvement of a first one of two characteristics causes degradation of a second one.

In this regard, if the electrolytic solution includes the fluorinated alcohol together with the nitrile compound and the two conditions are satisfied regarding the contents C1 and C2, a synergistic action of the nitrile compound and the fluorinated alcohol results in formation of a favorable film on the surface of the negative electrode upon charging and discharging of the lithium-ion secondary battery including the electrolytic solution. The film serves as a protective film covering the surface of an electrode having high reactivity, and has low electric resistance.

A possible reason why the foregoing film is low in electric resistance is as follows. If the electrolytic solution includes fluorinated alcohol together with the nitrile compound, the fluorinated alcohol is reduced preferentially over the nitrile compound at the surface of the negative electrode. In this case, a film including lithium ions, more specifically, a film including, for example, lithium alkoxide is formed. Accordingly, even upon film formation on the negative electrode, a movement path of lithium ions is secured in the film, which presumably decreases the electric resistance of the film.

Note that the lithium ion described here is a substance that moves between a positive electrode and the negative electrode upon an operation (upon charging and discharging) of the lithium-ion secondary battery, and is what is called an electrode reactant.

For the above-described reasons, the electric resistance of the electrolytic solution is so suppressed as not to excessively increase even if the electrolytic solution includes the nitrile compound, and the decomposition reaction of the electrolytic solution at the surface of the negative electrode is also suppressed. Accordingly, the above-described trade-off relationship between suppression of the gas generation and suppression of the increase in electric resistance is overcome, which allows the lithium-ion secondary battery including the electrolytic solution to decrease in electric resistance.

A magnitude relationship between the contents C1 and C2 is not particularly limited, and may be set as desired. In particular, it is preferable that the content C1 be greater than or equal to the content C2 and therefore a ratio of the content C1 to the content C2 (=C1/C2) be 1 or greater. It is more preferable that the content C1 be greater than the content C2 and therefore the ratio of the content C1 to the content C2 be greater than 1, in particular. One reason for this is that this allows the lithium-ion secondary battery including the electrolytic solution to sufficiently decrease in electric resistance.

More specifically, if the content C1 is less than the content C2 and therefore the ratio is less than 1, a film derived mainly from the fluorinated alcohol, that is, a film having a fluorous property, is easily formed on the surface of the negative electrode. This increases transport resistance of each of the lithium ion, a later-described solvent, and a solvated lithium ion, and can thus increase the electric resistance of the film.

In contrast, if the content C1 is greater than or equal to the content C2 and therefore the ratio is 1 or greater, the above-described film having the fluorous property is not easily formed on the surface of the negative electrode. This decreases the transport resistance of each of the lithium ion, the solvent, and the solvated lithium ion, and thus suppresses an increase in electric resistance of the film.

To measure the content C1 of the nitrile compound in the electrolytic solution, the lithium-ion secondary battery is disassembled to thereby recover the electrolytic solution, following which the electrolytic solution is analyzed to thereby calculate the content of the nitrile compound. A method of analyzing the electrolytic solution specifically includes any one or more of methods including, for example, high-frequency inductively coupled plasma (ICP) atomic emission spectroscopy, nuclear magnetic resonance spectroscopy (NMR), and gas chromatography-mass spectroscopy (GC-MS), although not particularly limited thereto.

A procedure for measuring the content C2 of the fluorinated alcohol in the electrolytic solution is similar to the above-described procedure for measuring the content of the nitrile compound in the electrolytic solution, except that the fluorinated alcohol is targeted for the measurement, instead of the nitrile compound.

The electrolytic solution may further include a solvent. The solvent includes any one or more of non-aqueous solvents (organic solvents). The electrolytic solution including the one or more non-aqueous solvents is what is called a non-aqueous electrolytic solution. The non-aqueous solvent includes, for example, an ester or an ether, more specifically, a carbonic-acid-ester-based compound, a carboxylic-acid-ester-based compound, or a lactone-based compound, for example.

The carbonic-acid-ester-based compound is, for example, a cyclic carbonic acid ester or a chain carbonic acid ester. Specific examples of the cyclic carbonic acid ester include ethylene carbonate and propylene carbonate. Specific examples of the chain carbonic acid ester include dimethyl carbonate, diethyl carbonate, and ethyl methyl carbonate.

The carboxylic-acid-ester-based compound is, for example, a chain carboxylic acid ester. Specific examples of the chain carboxylic acid ester include methyl acetate, ethyl acetate, propyl acetate, methyl propionate, ethyl propionate, propyl propionate, methyl trimethylacetate, ethyl trimethylacetate, methyl butyrate, and ethyl butyrate.

The lactone-based compound is, for example, a lactone. Specific examples of the lactone include γ-butyrolactone and γ-valerolactone.

Note that the ether may be a compound in which the ether is partially fluorinated. Specific examples of the ether include 1,2-dimethoxyethane, tetrahydrofuran, 1,3-dioxolane, 1,4-dioxane, and 1,1,2-tetrafluoroethyl 2,2,2,3,3-tetrafluoropropyl ether.

The solvent preferably includes the cyclic carbonic acid ester and the chain carbonic acid ester, in particular. One reason for this is that this allows the lithium-ion secondary battery including the electrolytic solution to decrease in electric resistance as described above, while stably achieving a high battery capacity. A further reason is that, in the lithium-ion secondary battery, it becomes easier to sufficiently retain a chemical state of the electrolytic solution and a discharge capacity is sufficiently prevented from easily decreasing even upon repeated charging and discharging.

The electrolytic solution may further include an electrolyte salt. The electrolyte salt is a light metal salt such as a lithium salt.

Specific examples of the lithium salt include lithium hexafluorophosphate (LiPF₆), lithium tetrafluoroborate (LiBF₄), lithium trifluoromethanesulfonate (LiCF₃SO₃), lithium bis(fluorosulfonyl)imide (LiN(FSO₂)₂), lithium bis(trifluoromethanesulfonyl)imide (LiN(CF₃SO₂)₂), lithium tris(trifluoromethanesulfonyl)methide (LiC(CF₃SO₂)₃), lithium bis(oxalato)borate (LiB(C₂O₄)₂), lithium monofluorophosphate (Li₂PFO₃), and lithium difluorophosphate (LiPF₂O₂). One reason for this is that a high battery capacity is obtainable.

A content of the electrolyte salt is specifically within a range from 0.3 mol/kg to 3.0 mol/kg both inclusive with respect to the solvent, although not particularly limited thereto. One reason for this is that high ion conductivity is obtainable.

The electrolytic solution may further include any one or more of additives. One reason for this is that this improves electrochemical stability of the electrolytic solution, and accordingly suppresses the decomposition reaction of the electrolytic solution in the lithium-ion secondary battery including the electrolytic solution.

The additives are not particularly limited in kind, and specifically include, for example, an unsaturated cyclic carbonic acid ester, a fluorinated cyclic carbonic acid ester, a sulfonic acid ester, a phosphoric acid ester, an acid anhydride, and an isocyanate compound.

Specific examples of the unsaturated cyclic carbonic acid ester include vinylene carbonate, vinyl ethylene carbonate, and methylene ethylene carbonate. Specific examples of the fluorinated cyclic carbonic acid ester include monofluoroethylene carbonate and difluoroethylene carbonate. Specific examples of the sulfonic acid ester include propane sultone and propene sultone. Specific examples of the phosphoric acid ester include trimethyl phosphate and triethyl phosphate. Specific examples of the acid anhydride include succinic anhydride, 1,2-ethanedisulfonic anhydride, and 2-sulfobenzoic anhydride. Specific examples of the isocyanate compound include hexamethylene diisocyanate.

An example method of manufacturing the electrolytic solution is as described below. Specifically, the electrolyte salt is added to the solvent, following which the nitrile compound and the fluorinated alcohol are added to the solvent. The electrolyte salt, the nitrile compound, and the fluorinated alcohol are each thereby dispersed or dissolved in the solvent. Thus, the electrolytic solution is prepared.

In manufacturing the electrolytic solution, the content of each of the nitrile compound and the fluorinated alcohol is adjusted to satisfy the two conditions regarding the contents C1 and C2 as described above.

According to the electrolytic solution, the electrolytic solution includes the nitrile compound and the fluorinated alcohol, and the two conditions are satisfied regarding the contents C1 and C2. More specifically, the content C1 is within the range from 0.5 wt % to 5 wt % both inclusive, and the content C2 is within the range from 0.05 wt % to 1 wt % both inclusive.

In this case, as described above, the relationship between the contents C1 and C2 is made appropriate when the nitrile compound and the fluorinated alcohol are used in combination. As a result, owing to the synergistic action of the nitrile compound and the fluorinated alcohol, a favorable film having low electric resistance is formed on the surface of the negative electrode upon charging and discharging of the lithium-ion secondary battery including the electrolytic solution. Accordingly, the electric resistance is so suppressed as not to excessively increase, and the decomposition reaction of the electrolytic solution at the surface of the negative electrode is also suppressed. The trade-off relationship between suppression of the gas generation and suppression of the increase in electric resistance is thus overcome.

For the above-described reasons, the lithium-ion secondary battery including the electrolytic solution decreases in electric resistance, which makes it possible to achieve a superior battery characteristic.

In particular, the nitrile compound may include two cyano groups in the molecule, and therefore the nitrile compound may include a dinitrile compound. This makes it easier for the favorable film to be formed on the surface of the negative electrode in the lithium-ion secondary battery including the electrolytic solution. Accordingly, the gas generation is further suppressed, which makes it possible to achieve higher effects.

In Formula (1), two or more of R1, R2, or R3 may each be the fluorinated alkyl group. This makes it easier for the favorable film to be formed on the surface of the negative electrode in the lithium-ion secondary battery including the electrolytic solution. Accordingly, the electric resistance sufficiently decreases, which makes it possible to achieve higher effects.

The electrolytic solution may further include the cyclic carbonic acid ester and the chain carbonic acid ester. This decreases the electric resistance while securing the battery capacity in the lithium-ion secondary battery including the electrolytic solution. Furthermore, it becomes easier to sufficiently retain the chemical state of the electrolytic solution and the discharge capacity is sufficiently prevented from easily decreasing even upon repeated charging and discharging. Accordingly, it is possible to achieve higher effects.

A description is given next of a lithium-ion secondary battery according to an embodiment of the present technology. The lithium-ion secondary battery includes the electrolytic solution described above.

The lithium-ion secondary battery to be described here is a secondary battery in which a battery capacity is obtained through insertion and extraction of lithium, and includes a positive electrode, a negative electrode, and the electrolytic solution. In the lithium-ion secondary battery, a sufficient battery capacity is stably obtainable through insertion and extraction of lithium.

Note that a charge capacity of the negative electrode is preferably greater than a discharge capacity of the positive electrode. In other words, an electrochemical capacity per unit area of the negative electrode is preferably greater than an electrochemical capacity per unit area of the positive electrode. This is to prevent precipitation of lithium metal on the surface of the negative electrode during charging.

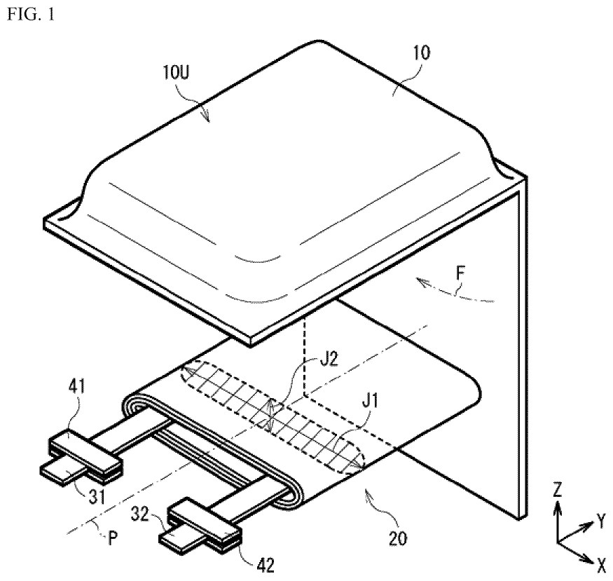

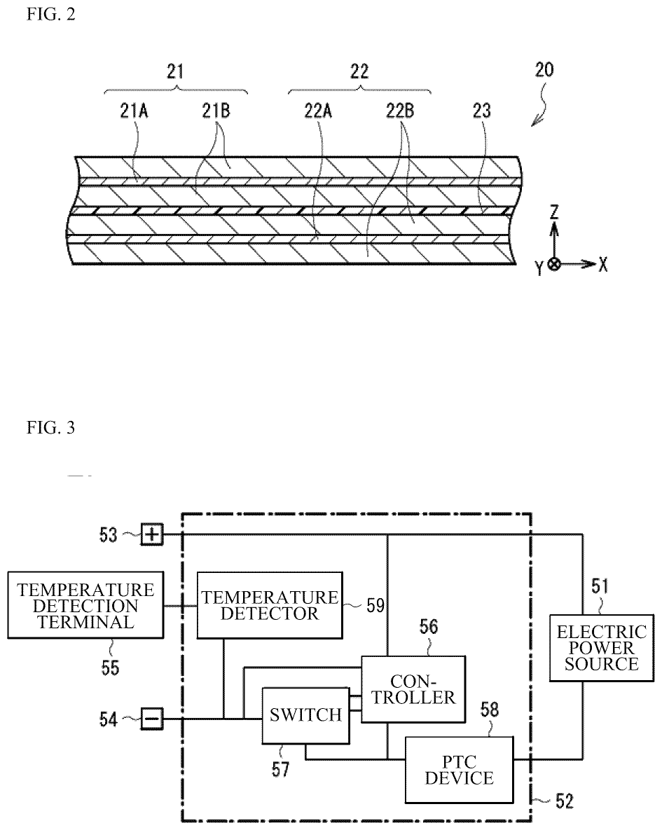

FIG. 1 illustrates a perspective configuration of the lithium-ion secondary battery. FIG. 2 illustrates a sectional configuration of a battery device 20 illustrated in FIG. 1. Note that FIG. 1 illustrates a state where an outer package film 10 and the battery device 20 are separated from each other, and illustrates a section of the battery device 20 along an XZ plane in a dashed line.

As illustrated in FIGS. 1 and 2, the lithium-ion secondary battery includes the outer package film 10, the battery device 20, a positive electrode lead 31, a negative electrode lead 32, and sealing films 41 and 42. The lithium-ion secondary battery described here is a lithium-ion secondary battery of a laminated-film type that includes the outer package film 10 having flexibility or softness.

The outer package film 10 is an outer package member that contains the battery device 20, as illustrated in FIG. 1. The outer package film 10 has a pouch-shaped structure that is sealed in a state where the battery device 20 is contained inside the outer package film 10. The outer package film 10 thus contains a positive electrode 21 and a negative electrode 22 to be described later, and also the electrolytic solution.

Here, the outer package film 10 is a single film-shaped member and is folded toward a folding direction F. The outer package film 10 has a depression part 10U to place the battery device 20 therein. The depression part 10U is what is called a deep drawn part.

Specifically, the outer package film 10 is a three-layered laminated film including a fusion-bonding layer, a metal layer, and a surface protective layer that are stacked in this order from an inner side. In a state where the outer package film 10 is folded, outer edge parts of the fusion-bonding layer opposed to each other are fusion-bonded to each other. The fusion-bonding layer includes a polymer compound such as polypropylene. The metal layer includes a metal material such as aluminum. The surface protective layer includes a polymer compound such as nylon.

Note that the outer package film 10 is not particularly limited in configuration or the number of layers, and may thus be single-layered or two-layered, or may include four or more layers.

The battery device 20 is a power generation device including, as illustrated in FIGS. 1 and 2, the positive electrode 21, the negative electrode 22, a separator 23, and the electrolytic solution (not illustrated). The battery device 20 is contained inside the outer package film 10.

The battery device 20 is what is called a wound electrode body. More specifically, the positive electrode 21 and the negative electrode 22 are stacked on each other with the separator 23 interposed therebetween, and are wound about a winding axis P in a state of being opposed to each other with the separator 23 interposed therebetween. The winding axis P is a virtual axis extending in a Y-axis direction.

The battery device 20 is not particularly limited in three-dimensional shape. Here, the battery device 20 has an elongated three-dimensional shape. Accordingly, a section of the battery device 20 intersecting the winding axis P, that is, a section of the battery device 20 along the XZ plane, has an elongated shape defined by a major axis J1 and a minor axis J2. The major axis J1 is a virtual axis that extends in an X-axis direction and has a length greater than a length of the minor axis J2. The minor axis J2 is a virtual axis that extends in a Z-axis direction intersecting the X-axis direction and has the length smaller than the length of the major axis J1. Here, the three-dimensional shape of the battery device 20 is an elongated cylindrical shape, and the section of the battery device 20 thus has an elongated, substantially elliptical shape.

As illustrated in FIG. 2, the positive electrode 21 includes a positive electrode current collector 21A and a positive electrode active material layer 21B.

The positive electrode current collector 21A has two opposed surfaces on each of which the positive electrode active material layer 21B is to be provided. The positive electrode current collector 21A includes an electrically conductive material such as a metal material. Specific examples of the electrically conductive material include aluminum.

Here, the positive electrode active material layer 21B is provided on each of the two opposed surfaces of the positive electrode current collector 21A. The positive electrode active material layer 21B includes any one or more of positive electrode active materials that each allow lithium to be inserted thereinto and extracted therefrom. Note that the positive electrode active material layer 21B may be provided only on one of the two opposed surfaces of the positive electrode current collector 21A on a side where the positive electrode 21 is opposed to the negative electrode 22. The positive electrode active material layer 21B may further include any one or more of other materials including, without limitation, a positive electrode binder and a positive electrode conductor. A method of forming the positive electrode active material layer 21B is not particularly limited, and specific examples thereof include a coating method.

The positive electrode active material includes a lithium-containing compound. The lithium-containing compound is a compound that includes lithium and one or more transition metal elements as constituent elements. The lithium-containing compound may further include one or more of other elements as one or more constituent elements. The other elements are not particularly limited in kind, and are any elements other than lithium and the transition metal elements. Specifically, the other elements are elements belonging to groups 2 to 15 in the long period periodic table. The lithium-containing compound is not particularly limited in kind, and is specifically, for example, an oxide, a phosphoric acid compound, a silicic acid compound, or a boric acid compound.

Specific examples of the oxide include LiNiO₂, LiCoO₂, LiCo_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.175}N_{10.1}O₂, Li_{1.15}(Mn_{0.65}Ni_{0.22}Co_{0.13})O₂, and LiMn₂O₄. Specific examples of the phosphoric acid compound include LiFePO₄, LiMnPO₄, LiFe_{0.5}Mn_{0.5}PO₄, and LiFe_{0.3}Mn_{0.7}PO₄.

The positive electrode binder includes any one or more of compounds including, without limitation, a synthetic rubber and a polymer compound. Specific examples of the synthetic rubber include a styrene-butadiene-based rubber, a fluorine-based rubber, and ethylene propylene diene. Specific examples of the polymer compound include polyvinylidene difluoride, polyimide, and carboxymethyl cellulose.

The positive electrode conductor includes any one or more of electrically conductive materials including, without limitation, a carbon material. Specific examples of the electrically conductive materials include graphite, carbon black, acetylene black, Ketjen black, carbon fibers, carbon nanofibers, and carbon nanotubes. Note that examples of the electrically conductive materials may further include a metal material and an electrically conductive polymer compound.

As illustrated in FIG. 2, the negative electrode 22 includes a negative electrode current collector 22A and a negative electrode active material layer 22B.

The negative electrode current collector 22A has two opposed surfaces on each of which the negative electrode active material layer 22B is to be provided. The negative electrode current collector 22A includes an electrically conductive material such as a metal material. Specific examples of the electrically conductive material include copper.

Here, the negative electrode active material layer 22B is provided on each of the two opposed surfaces of the negative electrode current collector 22A. The negative electrode active material layer 22B includes any one or more of negative electrode active materials that each allow lithium to be inserted thereinto and extracted therefrom. Note that the negative electrode active material layer 22B may be provided only on one of the two opposed surfaces of the negative electrode current collector 22A on a side where the negative electrode 22 is opposed to the positive electrode 21. The negative electrode active material layer 22B may further include any one or more of other materials including, without limitation, a negative electrode binder and a negative electrode conductor. A method of forming the negative electrode active material layer 22B is not particularly limited, and specific examples thereof include a coating method.

The negative electrode active material includes any one or more of materials including, without limitation, a carbon material and a metal-based material. One reason for this is that a high energy density is obtainable.

Specific examples of the carbon material include graphitizable carbon, non-graphitizable carbon, and graphite. The graphite may be natural graphite, artificial graphite, or both.

The metal-based material is a material that includes, as one or more constituent elements, any one or more elements among metal elements and metalloid elements that are each able to form an alloy with lithium. Specific examples of such metal elements and metalloid elements include silicon and tin. The metal-based material may be a simple substance, an alloy, a compound, a mixture of two or more thereof, or a material including two or more phases thereof. Specific examples of the metal-based material include TiSi₂ and SiOₓ (where 0<x≤2 or 0.2<x<1.4).

Details of the negative electrode binder are similar to the details of the positive electrode binder. Details of the negative electrode conductor are similar to the details of the positive electrode conductor.

The separator 23 is an insulating porous film interposed between the positive electrode 21 and the negative electrode 22 as illustrated in FIG. 2, and allows lithium ions to pass therethrough while preventing contact (a short circuit) between the positive electrode 21 and the negative electrode 22. The separator 23 includes a polymer compound such as polyethylene.

Details of the electrolytic solution are as described above. More specifically, the electrolytic solution includes the nitrile compound and the fluorinated alcohol, and satisfies the two conditions regarding the contents C1 and C2.

As illustrated in FIGS. 1 and 2, the positive electrode lead 31 is a positive electrode terminal coupled to the positive electrode current collector 21A of the positive electrode 21, and is led to an outside of the outer package film 10. The positive electrode lead 31 includes an electrically conductive material such as a metal material. Specific examples of the electrically conductive material include aluminum. The positive electrode lead 31 is not particularly limited in shape, and specifically has any of shapes including, without limitation, a thin plate shape and a meshed shape.

As illustrated in FIGS. 1 and 2, the negative electrode lead 32 is a negative electrode terminal coupled to the negative electrode current collector 22A of the negative electrode 22, and is led to the outside of the outer package film 10. The negative electrode lead 32 includes an electrically conductive material such as a metal material. Specific examples of the electrically conductive material include copper. Details of a direction in which the negative electrode lead 32 is led are similar to those of the direction in which the positive electrode lead 31 is led. Details of a shape of the negative electrode lead 32 are similar to those of the shape of the positive electrode lead 31.

The sealing film 41 is interposed between the outer package film 10 and the positive electrode lead 31. The sealing film 42 is interposed between the outer package film 10 and the negative electrode lead 32. Note that the sealing film 41, the sealing film 42, or both may be omitted.

The sealing film 41 is a sealing member that prevents entry of, for example, outside air into the outer package film 10. The sealing film 41 includes a polymer compound such as a polyolefin that has adherence to the positive electrode lead 31. Specific examples of the polyolefin include polypropylene.

The sealing film 42 has a configuration similar to that of the sealing film 41 except that the sealing film 42 is a sealing member that has adherence to the negative electrode lead 32. More specifically, the sealing film 42 includes a polymer compound such as a polyolefin that has adherence to the negative electrode lead 32.

The lithium-ion secondary battery operates as described below.

Upon charging, in the battery device 20, lithium is extracted in an ionic state from the positive electrode 21, and the extracted lithium is inserted in the ionic state into the negative electrode 22 via the electrolytic solution. Upon discharging, in the battery device 20, lithium is extracted in the ionic state from the negative electrode 22, and the extracted lithium is inserted in the ionic state into the positive electrode 21 via the electrolytic solution.

To manufacture the lithium-ion secondary battery, the positive electrode 21 and the negative electrode 22 are each fabricated and the electrolytic solution is prepared, following which the lithium-ion secondary battery is assembled using the positive electrode 21, the negative electrode 22, and the electrolytic solution, and the lithium-ion secondary battery thus assembled is subjected to a stabilization process, in accordance with an example procedure described below.

First, a mixture (a positive electrode mixture) in which the positive electrode active material, the positive electrode binder, and the positive electrode conductor are mixed with each other is put into a solvent to thereby prepare a positive electrode mixture slurry in paste form. The solvent may be an aqueous solvent, or may be an organic solvent. Thereafter, the positive electrode mixture slurry is applied on the two opposed surfaces of the positive electrode current collector 21A to thereby form the positive electrode active material layers 21B. Lastly, the positive electrode active material layers 21B may be compression-molded using, for example, a roll pressing machine. In this case, the positive electrode active material layers 21B may be heated. The positive electrode active material layers 21B may be compression-molded multiple times. The positive electrode active material layers 21B are thus formed on the two respective opposed surfaces of the positive electrode current collector 21A. As a result, the positive electrode 21 is fabricated.

The negative electrode 22 is fabricated by a procedure similar to the fabrication procedure of the positive electrode 21 described above. Specifically, a mixture (a negative electrode mixture) in which the negative electrode active material, the negative electrode binder, and the negative electrode conductor are mixed with each other is put into a solvent to thereby prepare a negative electrode mixture slurry in paste form. Thereafter, the negative electrode mixture slurry is applied on the two opposed surfaces of the negative electrode current collector 22A to thereby form the negative electrode active material layers 22B. The negative electrode active material layers 22B may be compression-molded thereafter. The negative electrode active material layers 22B are thus formed on the two respective opposed surfaces of the negative electrode current collector 22A. As a result, the negative electrode 22 is fabricated.

The electrolytic solution including the nitrile compound and the fluorinated alcohol is prepared by the procedure described above.

First, the positive electrode lead 31 is coupled to the positive electrode current collector 21A of the positive electrode 21 by a joining method such as a welding method, and the negative electrode lead 32 is coupled to the negative electrode current collector 22A of the negative electrode 22 by a joining method such as the welding method.

Thereafter, the positive electrode 21 and the negative electrode 22 are stacked on each other with the separator 23 interposed therebetween to thereby form a stacked body, following which the stacked body is wound to thereby fabricate a wound body (not illustrated). The wound body has a configuration similar to that of the battery device 20 except that the positive electrode 21, the negative electrode 22, and the separator 23 are each not impregnated with the electrolytic solution. Thereafter, the wound body is pressed using, for example, a pressing machine to thereby shape the wound body into an elongated shape.

Thereafter, the wound body is placed inside the depression part 10U, following which the outer package film 10 (the fusion-bonding layer/the metal layer/the surface protective layer) is folded to thereby cause parts of the outer package film 10 to be opposed to each other. Thereafter, outer edge parts of two sides of the fusion-bonding layer opposed to each other are bonded to each other by a bonding method such as a thermal-fusion-bonding method to thereby allow the wound body to be contained inside the outer package film 10 having a pouch shape.

Lastly, the electrolytic solution is injected into the outer package film 10 having the pouch shape, following which outer edge parts of the remaining one side of the fusion-bonding layer opposed to each other are bonded to each other by a bonding method such as the thermal-fusion-bonding method. In this case, the sealing film 41 is interposed between the outer package film 10 and the positive electrode lead 31, and the sealing film 42 is interposed between the outer package film 10 and the negative electrode lead 32.

The wound body is thereby impregnated with the electrolytic solution. Thus, the battery device 20, i.e., the wound electrode body, is fabricated. The battery device 20 is thus sealed in the outer package film 10 having the pouch shape. As a result, the lithium-ion secondary battery is assembled.

The lithium-ion secondary battery after being assembled is charged and discharged. Various conditions including, for example, an environment temperature, the number of times of charging and discharging (the number of cycles), and charging and discharging conditions, may be set as desired. A film is thereby formed on the surface of each of the positive electrode 21 and the negative electrode 22. This electrochemically stabilizes a state of the lithium-ion secondary battery. The lithium-ion secondary battery is thus completed.

According to the foregoing lithium-ion secondary battery, the lithium-ion secondary battery includes the electrolytic solution, and the electrolytic solution has the configuration described above. For the reasons described above, a favorable film having low electric resistance is thus formed on the surface of the negative electrode 22. Accordingly, the electric resistance of the electrolytic solution is so suppressed as not to excessively increase, and the decomposition reaction of the electrolytic solution at the surface of the negative electrode 22 is also suppressed. This results in lower electric resistance and thus makes it possible to achieve a superior battery characteristic.

Other action and effects of the lithium-ion secondary battery are similar to those of the electrolytic solution.

The configuration of the lithium-ion secondary battery is appropriately modifiable as described below according to an embodiment. Note that any two or more of the following series of modification examples may be combined with each other.

The separator 23 that is a porous film is used. However, although not specifically illustrated here, a separator of a stacked type including a polymer compound layer may be used.

Specifically, the separator of the stacked type includes a porous film having two opposed surfaces, and the polymer compound layer provided on one of or each of the two opposed surfaces of the porous film. One reason for this is that adherence of the separator to each of the positive electrode 21 and the negative electrode 22 improves to suppress winding displacement of the battery device 20. This suppresses swelling of the lithium-ion secondary battery even if the decomposition reaction of the electrolytic solution occurs. The polymer compound layer includes a polymer compound such as polyvinylidene difluoride. One reason for this is that polyvinylidene difluoride is superior in physical strength and is electrochemically stable.

Note that the porous film, the polymer compound layer, or both may include multiple insulating particles. One reason for this is that the insulating particles promote heat dissipation upon heat generation by the lithium-ion secondary battery, and thus improve safety or heat resistance of the lithium-ion secondary battery. The insulating particles include any one or more of insulating materials including, without limitation, inorganic materials and resin materials. Specific examples of the inorganic materials include aluminum oxide, aluminum nitride, boehmite, silicon oxide, titanium oxide, magnesium oxide, and zirconium oxide. Specific examples of the resin materials include acrylic resin and styrene resin.

To fabricate the separator of the stacked type, a precursor solution including, without limitation, the polymer compound and a solvent is prepared, following which the precursor solution is applied on one of or each of the two opposed surfaces of the porous film. In this case, the insulating particles may be added to the precursor solution on an as-needed basis.

When the separator of the stacked type is used also, lithium is movable between the positive electrode 21 and the negative electrode 22, and similar effects are therefore achievable. In this case, in particular, the lithium-ion secondary battery improves in safety, as described above. Accordingly, it is possible to achieve higher effects.

The electrolytic solution, i.e., a liquid electrolyte, is used. However, although not specifically illustrated here, an electrolyte layer may be used. The electrolyte layer is a gel electrolyte.

In the battery device 20 including the electrolyte layer, the positive electrode 21 and the negative electrode 22 are stacked on each other with the separator 23 and the electrolyte layer interposed therebetween, and the stack of the positive electrode 21, the negative electrode 22, the separator 23, and the electrolyte layer is wound. The electrolyte layer is interposed between the positive electrode 21 and the separator 23, and between the negative electrode 22 and the separator 23.

Specifically, the electrolyte layer includes a polymer compound together with the electrolytic solution. The electrolytic solution is held by the polymer compound. One reason for this is that this prevents leakage of the electrolytic solution. The electrolytic solution has the configuration described above. The polymer compound includes, for example, polyvinylidene difluoride. To form the electrolyte layer, a precursor solution including, without limitation, the electrolytic solution, the polymer compound, and a solvent is prepared, following which the precursor solution is applied on one side or both sides of the positive electrode 21 and on one side or both sides of the negative electrode 22.

When the electrolyte layer is used also, lithium is movable between the positive electrode 21 and the negative electrode 22 via the electrolyte layer, and similar effects are therefore achievable. In this case, in particular, the leakage of the electrolytic solution is prevented, as described above. Accordingly, it is possible to achieve higher effects.

Applications (application examples) of the lithium-ion secondary battery are not particularly limited. The lithium-ion secondary battery used as a power source may serve as a main power source or an auxiliary power source of, for example, electronic equipment or an electric vehicle. The main power source is preferentially used regardless of the presence of any other power source. The auxiliary power source may be used in place of the main power source, or may be switched from the main power source.

Specific examples of the applications of the lithium-ion secondary battery include: electronic equipment; apparatuses for data storage; electric power tools; battery packs to be mounted on, for example, electronic equipment; medical electronic equipment; electric vehicles; and electric power storage systems. Examples of the electronic equipment include video cameras, digital still cameras, mobile phones, laptop personal computers, headphone stereos, portable radios, and portable information terminals. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include battery systems for home use or industrial use in which electric power is accumulated for a situation such as emergency. In each of the above-described applications, one lithium-ion secondary battery may be used, or multiple lithium-ion secondary batteries may be used.

The battery pack may include a battery cell, or may include an assembled battery. The electric vehicle is a vehicle that operates (travels) using the lithium-ion secondary battery as a driving power source, and may be a hybrid automobile that is additionally provided with another driving source different from the lithium-ion secondary battery. In the electric power storage system for home use, electric power accumulated in the lithium-ion secondary battery that is an electric power storage source may be utilized for using, for example, home appliances.

An application example of the lithium-ion secondary battery will now be described in detail. The configuration of the application example described below is merely an example, and is appropriately modifiable.

FIG. 3 illustrates a block configuration of a battery pack. The battery pack described here is a battery pack (what is called a soft pack) including one lithium-ion secondary battery, and is to be mounted on, for example, electronic equipment typified by a smartphone.

The battery pack includes an electric power source 51 and a circuit board 52, as illustrated in FIG. 3. The circuit board 52 is coupled to the electric power source 51, and includes a positive electrode terminal 53, a negative electrode terminal 54, and a temperature detection terminal 55.

The electric power source 51 includes one lithium-ion secondary battery. The lithium-ion secondary battery has a positive electrode lead coupled to the positive electrode terminal 53 and a negative electrode lead coupled to the negative electrode terminal 54. The electric power source 51 is couplable to outside via the positive electrode terminal 53 and the negative electrode terminal 54, and is thus chargeable and dischargeable. The circuit board 52 includes a controller 56, a switch 57, a PTC device 58, and a temperature detector 59. However, the PTC device 58 may be omitted.

The controller 56 includes, for example, a central processing unit (CPU) and a memory, and controls an overall operation of the battery pack. The controller 56 detects and controls a use state of the electric power source 51 on an as-needed basis.

If a voltage of the electric power source 51 (the lithium-ion secondary battery) reaches an overcharge detection voltage or an overdischarge detection voltage, the controller 56 turns off the switch 57. This prevents a charging current from flowing into a current path of the electric power source 51. The overcharge detection voltage is not particularly limited, and is specifically 4.20 V±0.05 V. The overdischarge detection voltage is not particularly limited, and is specifically 2.40V±0.1 V.

The switch 57 includes, for example, a charge control switch, a discharge control switch, a charging diode, and a discharging diode. The switch 57 performs switching between coupling and decoupling between the electric power source 51 and external equipment in accordance with an instruction from the controller 56. The switch 57 includes, for example, a metal-oxide-semiconductor field-effect transistor (MOSFET). The charging current and a discharging current are each detected based on an ON-resistance of the switch 57.

The temperature detector 59 includes a temperature detection device such as a thermistor. The temperature detector 59 measures a temperature of the electric power source 51 through the temperature detection terminal 55, and outputs a result of the temperature measurement to the controller 56. The result of the temperature measurement obtained by the temperature detector 59 is used, for example, when the controller 56 performs charge and discharge control upon abnormal heat generation or when the controller 56 performs a correction process upon calculating a remaining capacity.

### EXAMPLES

A description is given of Examples of the present technology according to an embodiment.

### Examples 1 to 11 and Comparative Examples 1 to 7

As described below, lithium-ion secondary batteries were fabricated and thereafter, the fabricated lithium-ion secondary batteries were each evaluated for a battery characteristic.

### [Fabrication of Lithium-Ion Secondary Battery]

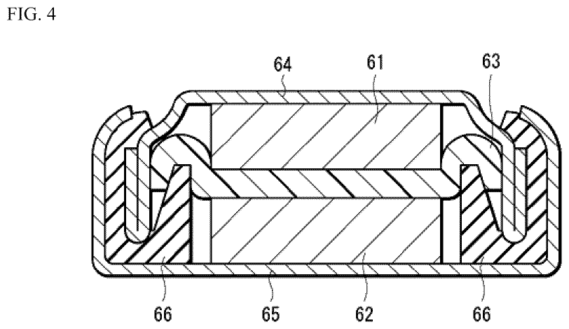

Here, lithium-ion secondary batteries for testing were each fabricated for simple evaluation of the battery characteristic. FIG. 4 illustrates a sectional configuration of the secondary battery for testing. The secondary battery for testing was a lithium-ion secondary battery of what is called a coin type.

In the following, a description will be given of the configuration of the lithium-ion secondary battery of the coin type, and thereafter, a description will be given of a procedure for fabricating the lithium-ion secondary battery.

As illustrated in FIG. 4, the lithium-ion secondary battery included a test electrode 61, a counter electrode 62, a separator 63, an outer package cup 64, an outer package can 65, a gasket 66, and an electrolytic solution (not illustrated).

The test electrode 61 was contained in the outer package cup 64, and the counter electrode 62 was contained in the outer package can 65. The test electrode 61 and the counter electrode 62 were stacked on each other with the separator 63 interposed therebetween. The test electrode 61, the counter electrode 62, and the separator 63 were each impregnated with the electrolytic solution. The outer package cup 64 and the outer package can 65 were crimped to each other with the gasket 66 interposed therebetween. The test electrode 61, the counter electrode 62, and the separator 63 were thus sealed in the outer package cup 64 and the outer package can 65.

### [Fabrication of Test Electrode]

To fabricate the lithium-ion secondary battery, first, 91 parts by mass of a positive electrode active material (LiNi_{0.80}Co_{0.15}Al_{0.05}O₂ as a lithium-containing compound (an oxide)), 3 parts by mass of a positive electrode binder (polyvinylidene difluoride), and 6 parts by mass of a positive electrode conductor (Ketjen black as amorphous carbon powder) were mixed with each other to thereby obtain a positive electrode mixture. Thereafter, the positive electrode mixture was put into a solvent (N-methyl-2-pyrrolidone as an organic solvent), following which the solvent was stirred to thereby prepare a positive electrode mixture slurry in paste form.

Thereafter, the positive electrode mixture slurry was applied on one of the two opposed surfaces of the positive electrode current collector 21A (an aluminum foil having a thickness of 10 μm) using a coating apparatus, following which the applied positive electrode mixture slurry was dried to thereby form the positive electrode active material layer 21B.

Lastly, the positive electrode active material layer 21B was compression-molded using a roll pressing machine, following which the positive electrode current collector 21A on which the positive electrode active material layer 21B was formed was cut into a circular plate shape. The test electrode 61 was thus fabricated.

### [Fabrication of Counter Electrode]

First, 94 parts by mass of a negative electrode active material (4 parts by mass of silicon oxide as a metal-based material and 90 parts by mass of artificial graphite as a carbon material), 1.5 parts by mass of a negative electrode binder (polyvinylidene difluoride), 2.5 parts by mass of a negative electrode conductor (2 parts by mass of carbon nanotubes and 0.5 parts by mass of graphite), and 2 parts by mass of a thickener (carboxymethyl cellulose) were mixed with each other to thereby obtain a negative electrode mixture.

Thereafter, the negative electrode mixture was put into a solvent (water as an aqueous solvent), following which the solvent was stirred to thereby prepare a negative electrode mixture slurry in paste form.

Thereafter, the negative electrode mixture slurry was applied on one of the two opposed surfaces of the negative electrode current collector 22A (a copper foil having a thickness of 8 μm) using a coating apparatus, following which the applied negative electrode mixture slurry was dried to thereby form the negative electrode active material layer 22B.

Lastly, the negative electrode active material layer 22B was compression-molded using a roll pressing machine, following which the negative electrode current collector 22A on which the negative electrode active material layer 22B was formed was cut into a circular plate shape. The counter electrode 62 was thus fabricated.

### [Preparation of Electrolytic Solution]

First, the solvent was prepared. Used as the solvent was a mixture of ethylene carbonate (EC) as a cyclic carbonic acid ester and ethyl methyl carbonate (EMC) as a chain carbonic acid ester. In this case, a mixture ratio (wt %) between EC and EMC in the solvent was set to 30:70.

Thereafter, the electrolyte salt (lithium hexafluorophosphate (LiPF₆) as a lithium salt) was added to the solvent, following which the solvent was stirred. In this case, the content of the electrolyte salt was set to 1 mol/kg with respect to the solvent.

Lastly, the nitrile compound and the fluorinated alcohol were added to the solvent including the electrolyte salt, following which the solvent was stirred. In this case, succinonitrile (SN; NCCH₂CH₂CN), i.e., a dinitrile compound, was used as the nitrile compound and hexafluoroisopropanol (HFIP; (CF₃)₂CHOH) was used as the fluorinated alcohol. The electrolytic solution was thus prepared.

In preparing the electrolytic solution, an addition amount of the nitrile compound was adjusted to allow the content C1 (wt %) of the nitrile compound in the electrolytic solution to have a value listed in Table 1, and an addition amount of the fluorinated alcohol was adjusted to allow the content C2 (wt %) of the fluorinated alcohol in the electrolytic solution to have values listed in Table 1.

An electrolytic solution for comparison was prepared by a similar procedure, except that no fluorinated alcohol was used.

### [Assembly of Lithium-Ion Secondary Battery]

First, the test electrode 61 was placed into the outer package cup 64, and the counter electrode 62 was placed into the outer package can 65. Thereafter, the test electrode 61 placed in the outer package cup 64 and the counter electrode 62 placed in the outer package can 65 were stacked on each other, with the separator 63 (a fine porous polyethylene film having a thickness of m) impregnated with the electrolytic solution being interposed between the test electrode 61 and the counter electrode 62. In this case, the positive electrode active material layer 21B and the negative electrode active material layer 22B were opposed to each other with the separator 63 interposed therebetween. Thereafter, in a state where the test electrode 61 and the counter electrode 62 were stacked on each other with the separator 63 interposed therebetween, the outer package cup 64 and the outer package can 65 were crimped to each other with the gasket 66 interposed therebetween. The test electrode 61 and the counter electrode 62 were thereby sealed in the outer package cup 64 and the outer package can 65. Thus, the lithium-ion secondary battery was assembled.

### [Stabilization Process]

The lithium-ion secondary battery was charged and discharged for one cycle in an ambient temperature environment (at a temperature of 23° C.). Upon charging, the lithium-ion secondary battery was charged with a constant current of 0.1 C until a voltage reached 4.2 V, and was thereafter charged with a constant voltage of that value, 4.2 V, until a current reached 0.025 C. Upon discharging, the lithium-ion secondary battery was discharged with a constant current of 0.1 C until the voltage reached 3.0 V. Note that 0.1 C was a value of a current that caused a battery capacity (a theoretical capacity) to be completely discharged in 10 hours, and 0.025 C was a value of a current that caused the battery capacity to be completely discharged in 40 hours.

The test electrode 61 and the counter electrode 62 were each thereby electrochemically stabilized. Thus, the lithium-ion secondary battery was completed.

### [Characteristic Evaluation of Lithium-Ion Secondary Battery]

The lithium-ion secondary batteries were each evaluated for the battery characteristic (an electric resistance characteristic) in accordance with the following procedure, and the evaluation revealed the results presented in Table 1.

To evaluate the electric resistance characteristic, an electrochemical impedance (EIS (Ω)) as an index for evaluating the electric resistance characteristic was measured by an alternating-current impedance method. The EIS is what is called a charge transfer resistance. Used as a measurement apparatus was a multi-channel potentiostat VMP-3 available from Bio-Logic Science Instruments. As measurement conditions, a frequency range was set to be from 1 MHz to 10 MHz both inclusive, and an alternating-current amplitude was set at 10 mV.

Note that values of the EIS listed in Table 1 are normalized values. Specifically, the values of the EIS in Examples 1 to 4 and Comparative examples 1 and 2 were each normalized with respect to the value of the EIS in Comparative example 1 which was assumed to be 100. The values of the EIS in Examples 5 to 8 and Comparative examples 3 and 4 were each normalized with respect to the value of the EIS in Comparative example 3 which was assumed to be 100. The values of the EIS in Examples 9 to 11 and Comparative examples 5 to 7 were each normalized with respect to the value of the EIS in Comparative example 5 which was assumed to be 100.

TABLE 1

| | Solvent | | Nitrile compound | | Fluorinated alcohol | | |
|---|---|---|---|---|---|---|---|
| | Cyclic carbonic | Chain carbonic | | Content | | Content | EIS |
| | acid ester | acid ester | Kind | C1 (wt %) | Kind | C2 (wt %) | (Normalized) |
| Example 1 | EC | EMC | SN | 0.5 | HFIP | 0.05 | 87 |
| Example 2 | EC | EMC | SN | 0.5 | HFIP | 0.25 | 83 |
| Example 3 | EC | EMC | SN | 0.5 | HFIP | 0.5 | 86 |
| Example 4 | EC | EMC | SN | 0.5 | HFIP | 1 | 90 |
| Example 5 | EC | EMC | SN | 1 | HFIP | 0.05 | 93 |
| Example 6 | EC | EMC | SN | 1 | HFIP | 0.1 | 90 |
| Example 7 | EC | EMC | SN | 1 | HFIP | 0.5 | 91 |
| Example 8 | EC | EMC | SN | 1 | HFIP | 1 | 99 |
| Example 9 | EC | EMC | SN | 5 | HFIP | 0.05 | 97 |
| Example 10 | EC | EMC | SN | 5 | HFIP | 0.5 | 98 |
| Example 11 | EC | EMC | SN | 5 | HFIP | 1 | 95 |
| Comparative example 1 | EC | EMC | SN | 0.5 | — | — | 100 |
| Comparative example 2 | EC | EMC | SN | 0.5 | HFIP | 2.5 | 111 |
| Comparative example 3 | EC | EMC | SN | 1 | — | — | 100 |
| Comparative example 4 | EC | EMC | SN | 1 | HFIP | 5 | 142 |
| Comparative example 5 | EC | EMC | SN | 5 | — | — | 100 |
| Comparative example 6 | EC | EMC | SN | 5 | HFIP | 2.5 | 110 |
| Comparative example 7 | EC | EMC | SN | 5 | HFIP | 5 | 144 |

As indicated in Table 1, the EIS varied greatly depending on the configuration of the electrolytic solution.

Specifically, the EIS increased when the following conditions were not satisfied (Comparative examples 1 to 7): the electrolytic solution including the nitrile compound and the fluorinated alcohol; the content C1 being within the range from 0.5 wt % to 5 wt % both inclusive; and that the content C2 being within the range from 0.05 wt % to 1 wt % both inclusive.

In contrast, the EIS decreased when the following conditions were satisfied (Examples 1 to 11): the electrolytic solution including the nitrile compound and the fluorinated alcohol; the content C1 being within the range from 0.5 wt % to 5 wt % both inclusive; and the content C2 being within the range from 0.05 wt % to 1 wt % both inclusive.

When the above-described conditions were satisfied (Examples 1 to 11), the following tendencies were obtained, in particular.

Firstly, the EIS sufficiently decreased by the use of the dinitrile compound (SN) as the nitrile compound, that is, by the use of a nitrile compound including two cyano groups in the molecule.

Secondly, the EIS sufficiently decreased by the use of HFIP as the fluorinated alcohol, that is, by the use of a fluorinated alcohol in which two or more of R1 to R3 in Formula (1) were fluorinated alkyl groups.

Thirdly, when the electrolytic solution included a solvent (the cyclic carbonic acid ester and the chain carbonic acid ester) together with the nitrile compound and the fluorinated alcohol, the EIS sufficiently decreased, with smooth charging and discharging reactions (the battery capacity) being secured.

The results presented in Table 1 indicate that when the electrolytic solution of the lithium-ion secondary battery included the nitrile compound and the fluorinated alcohol and the two conditions (the content C1=0.5 wt % to 5 wt %; and the content C2=0.05 wt % to 1 wt %) were satisfied regarding the contents C1 and C2, the EIS decreased. Accordingly, the electric resistance characteristic improved, which made it possible for the lithium-ion secondary battery to achieve a superior battery characteristic.

Although the present technology has been described herein with reference to one or more embodiments including Examples, the configuration of the present technology is not limited thereto, and is therefore modifiable in a variety of ways.

Specifically, the description has been given of the case where the lithium-ion secondary battery has a battery structure of the laminated-film type. However, the battery structure of the lithium-ion secondary battery according to the present technology is not particularly limited. Specifically, the battery structure of the lithium-ion secondary battery may be of, for example, a cylindrical type, a prismatic type, or the coin type.

Further, the description has been given of the case where the battery device has a device structure of a wound type. However, the device structure of the battery device is not particularly limited, and may thus be of, for example, a stacked type or a zigzag folded type. In the stacked type, the positive electrode and the negative electrode are alternately stacked with the separator interposed therebetween. In the zigzag folded type, the positive electrode and the negative electrode are opposed to each other with the separator interposed therebetween, and are folded in a zigzag manner.

The effects described herein are mere examples, and effects of the present technology are therefore not limited to those described herein. Accordingly, the present technology may achieve other effects.

Note that the present technology may have any of the following configurations according to an embodiment.

<1>

A lithium-ion secondary battery including:
a positive electrode;
a negative electrode; and
an electrolytic solution, in which
the electrolytic solution includes
   a nitrile compound that includes one or more cyano groups in a molecule, and
   a fluorinated alcohol represented by Formula (1),
a content of the nitrile compound in the electrolytic solution is greater than or equal to 0.5 weight percent and less than or equal to 5 weight percent, and
a content of the fluorinated alcohol in the electrolytic solution is greater than or equal to 0.05 weight percent and less than or equal to 1 weight percent,

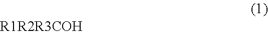

where
each of R1, R2, and R3 is any one of a hydrogen group, an alkyl group, or a fluorinated alkyl group, and
at least one of R1, R2, or R3 is the fluorinated alkyl group.
   <2>

The lithium-ion secondary battery according to <1>, in which the nitrile compound includes two of the cyano groups in the molecule.

<3>

The lithium-ion secondary battery according to <1> or <2>, in which two or more of R1, R2, or R3 are each the fluorinated alkyl group.

<4>

The lithium-ion secondary battery according to any one of <1> or <3>, in which the electrolytic solution further includes a cyclic carbonic acid ester and a chain carbonic acid ester.

<5>

An electrolytic solution for a lithium-ion secondary battery, the electrolytic solution including:
a nitrile compound that includes one or more cyano groups in a molecule; and
a fluorinated alcohol represented by Formula (1), in which
a content of the nitrile compound is greater than or equal to 0.5 weight percent and less than or equal to 5 weight percent, and
a content of the fluorinated alcohol is greater than or equal to 0.05 weight percent and less than or equal to 1 weight percent,

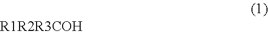

where
each of R1, R2, and R3 is any one of a hydrogen group, an alkyl group, or a fluorinated alkyl group, and
at least one of R1, R2, or R3 is the fluorinated alkyl group.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A lithium-ion secondary battery comprising:
a positive electrode;
a negative electrode; and
an electrolytic solution, wherein
the electrolytic solution includes
a nitrile compound that includes one or more cyano groups in a molecule, and
a fluorinated alcohol represented by Formula (1),
a content of the nitrile compound in the electrolytic solution is greater than or equal to 0.5 weight percent and less than or equal to 5 weight percent, and
a content of the fluorinated alcohol in the electrolytic solution is greater than or equal to 0.05 weight percent and less than or equal to 1 weight percent, 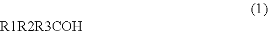
where
each of R1, R2, and R3 is any one of a hydrogen group, an alkyl group, or a fluorinated alkyl group, and
at least one of R1, R2, or R3 is the fluorinated alkyl group.

2. The lithium-ion secondary battery according to claim 1, wherein the nitrile compound includes two of the cyano groups in the molecule.

3. The lithium-ion secondary battery according to claim 1, wherein two or more of R1, R2, or R3 are each the fluorinated alkyl group.

4. The lithium-ion secondary battery according to claim 1, wherein the electrolytic solution further includes a cyclic carbonic acid ester and a chain carbonic acid ester.

5. An electrolytic solution for a lithium-ion secondary battery, the electrolytic solution comprising:
a nitrile compound that includes one or more cyano groups in a molecule; and
a fluorinated alcohol represented by Formula (1), wherein
a content of the nitrile compound is greater than or equal to 0.5 weight percent and less than or equal to 5 weight percent, and
a content of the fluorinated alcohol is greater than or equal to 0.05 weight percent and less than or equal to 1 weight percent, 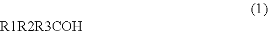
where
each of R1, R2, and R3 is any one of a hydrogen group, an alkyl group, or a fluorinated alkyl group, and
at least one of R1, R2, or R3 is the fluorinated alkyl group.
